(19) United States
(12) Patent Application Publication
(10) Pub. No.: US 2024/0078517 A1
(43) Pub. Date: Mar. 7, 2024

(54) Changing A Security Configuration Applied To A Digital Calendar

(71) Applicant: Zoom Video Communications, Inc., San Jose, CA (US)

(72) Inventor: Aleksandra Swerdlow, Santa Clara, CA (US)

(21) Appl. No.: 17/903,603

(22) Filed: Sep. 6, 2022

(51) Int. Cl. G06Q 10/10; G06Q 10/06

(52) U.S. Cl. CPC G06Q 10/109; G06Q 10/06311

(57) ABSTRACT

A system may apply a security configuration to a digital calendar corresponding to a first user. The digital calendar may be maintained by calendar software. The digital calendar may include an event having multiple event details including a date for the event and a time for the event. Access to the multiple event details may be limited to the first user by the security configuration. The system may access a data structure in a data store to determine a connection between the first user and a second user based on a user attribute associated with the second user. The system may change the security configuration to grant access to an event detail of the multiple event details to a device associated with the second user based on the connection between the first user and the second user.

### FIELD

This disclosure relates generally to digital calendaring and, more specifically, to changing a security configuration applied to a digital calendar.

### BRIEF DESCRIPTION OF THE DRAWINGS

This disclosure is best understood from the following detailed description when read in conjunction with the accompanying drawings. It is emphasized that, according to frequent practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a block diagram of an example of a system for changing a security configuration applied to a digital calendar.

FIG. 5 is a block diagram of an example of using security software to change a security configuration applied to a digital calendar.

FIG. 6 is a block diagram of an example of a data structure including an organizational chart.

FIG. 7 is a block diagram of an example of a data structure including a favorite contacts list.

FIG. 8 is a flowchart of an example of a technique for changing a security configuration applied to a digital calendar.

FIG. 9 is a flowchart of an example of a technique for monitoring for a connection change based on a user attribute.

### DETAILED DESCRIPTION OF THE DRAWINGS

Enterprise entities rely upon several modes of communication to support their operations, including telephone, email, internal messaging, and the like. These separate modes of communication have historically been implemented by service providers whose services are not integrated with one another. The disconnect between these services, in at least some cases, requires information to be manually passed by users from one service to the next. Furthermore, some services, such as telephony services, are traditionally delivered via on-premises systems, meaning that remote workers and those who are generally increasingly mobile may be unable to rely upon them. One type of system which addresses problems such as these includes a unified communications as a service (UCaaS) platform, which includes several communications services integrated over a network, such as the Internet, to deliver a complete communication experience regardless of physical location.

Individuals may use software, such as of a UCaaS or other software platform, to coordinate meetings (e.g., virtual meetings, via video conferencing, or in-person meetings) with one another. The meetings may be tracked as events on a digital calendar that is maintained by a calendar software tool or service. The events may include various event details, such as a date, a time, a title, a location, and/or a list of invitees.

Calendar software tools, such as those of conventional software platforms, generally involve the owner of the calendar, as a software user, granting permissions to other users for accessing the calendar. Such conventional tools may be inefficient to the extent that some users might not have access to another user's calendar to permit knowing the details of events, such as the title, the location, and/or the list of invitees for the event, unless such permission is granted. This may cause difficulty for the users to schedule events, such as by not knowing whether one event is more important than another. Such conventional tools may also suffer from requiring individual owners to find out how permissions can be granted to users and performing multiple steps to grant such permissions. This can be burdensome for each owner of a calendar, and may require each owner to manually check from time to time whether permissions should be changed

Implementations of this disclosure address problems such as these by applying a security configuration to a digital calendar that links access to one or more event details of an event on the calendar to a connection between an owner of the calendar and users of the calendar (e.g., schedulers of events or invitees to events). A system may use security software to apply a security configuration to the calendar. The calendar may correspond to a first user (e.g., an owner of the calendar). The calendar may include an event (e.g., a scheduled meeting) having multiple event details. For example, the event details could include a date, a time, a title, a location (e.g., a physical location or a virtual location), a list of invitees (e.g., email address aliases), content (e.g., an attachment or a link), and a prediction (e.g., a prediction that the event will occur as scheduled, a prediction that one or more invitees will attend the event, or a prediction that one or more invitees will speak more during the event more than one or more other invitees). Access to the event and/or the event details may be limited to the first user by the security configuration (e.g., a default configuration).

The system may access a data structure in a data store to determine a connection between the first user (e.g., the owner of the calendar) and a second user (e.g., a scheduler of an event or an invitee to an event). For example, the data structure could include an organizational chart, a favorite contacts list, a notification breakthrough list, or memberships to a chat channel. The data structure may indicate a group of users, including the first user and/or the second user, and may indicate multiple user attributes associated with users in the group of users, including a user attribute associated with the first user and/or a user attribute associated with the second user. The user attributes may include, for example, a position in an organization (e.g., a title or role), an identification in a contacts list or a favorite contacts list, a membership to a chat channel, or a network or domain corresponding to a device. The system may determine the connection between the first user and the second user based on the user attribute associated with the first user and/or the user attribute associated with the second user. For example, the connection could include the first user being senior to or subordinate to a second user in an organization, the first user and the second user belonging to a same team, department, or project in the organization, or the first user and the second user having a personal, familial, or business relationship. The system may use the connection to configure one or more rules for determining access to one or more event details of an event on the calendar for the second user. The system may change the security configuration to grant access to the one or more event details to a device associated with the second user based on the connection between the first user and the second user. Changing the security configuration may enable an output of the event detail to the device associated with the second user. As a result, the owner of a calendar may allow access to particular event details to one or more users while reducing the burden on the owner of individually managing permissions for the one or more users.

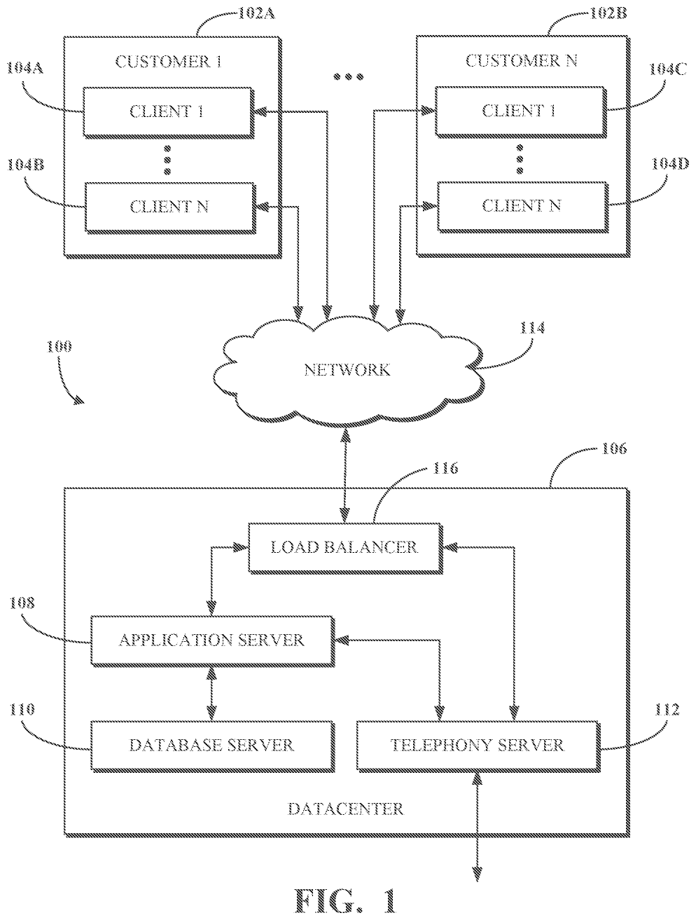

To describe some implementations in greater detail, reference is first made to examples of hardware and software structures used to implement a system for changing a security configuration applied to a digital calendar. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a UCaaS platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. In some implementations, the datacenter 106 can be associated or communicate with one or more datacenter networks or domains, which can include domains other than the customer domains for the customers 102A through 102B.

The datacenter 106 includes servers used for implementing software services of a UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UCaaS platform uses a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UCaaS platform. For example, the application server 108 can implement all or a portion of a UCaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, the client 104 or the application server 108.

The telephony server 112 enables network-based telephony and web communications from and to clients of a customer, such as the clients 104A through 104B for the customer 102A or the clients 104C through 104D for the customer 102B. Some or all of the clients 104A through 104D may be voice over internet protocol (VOIP)-enabled devices configured to send and receive calls over a network 114. In particular, the telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a public switched telephone network (PSTN) system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, a SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, a SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106. For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

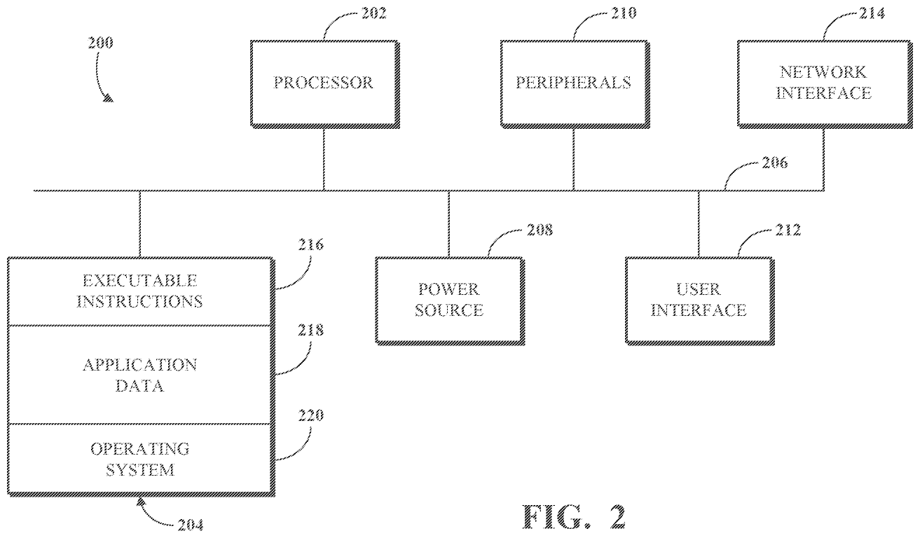

FIG. 2 is a block diagram of an example internal configuration of a computing device 200 of an electronic computing and communications system. In one configuration, the computing device 200 may implement one or more of the client 104, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR DRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, virtual reality display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

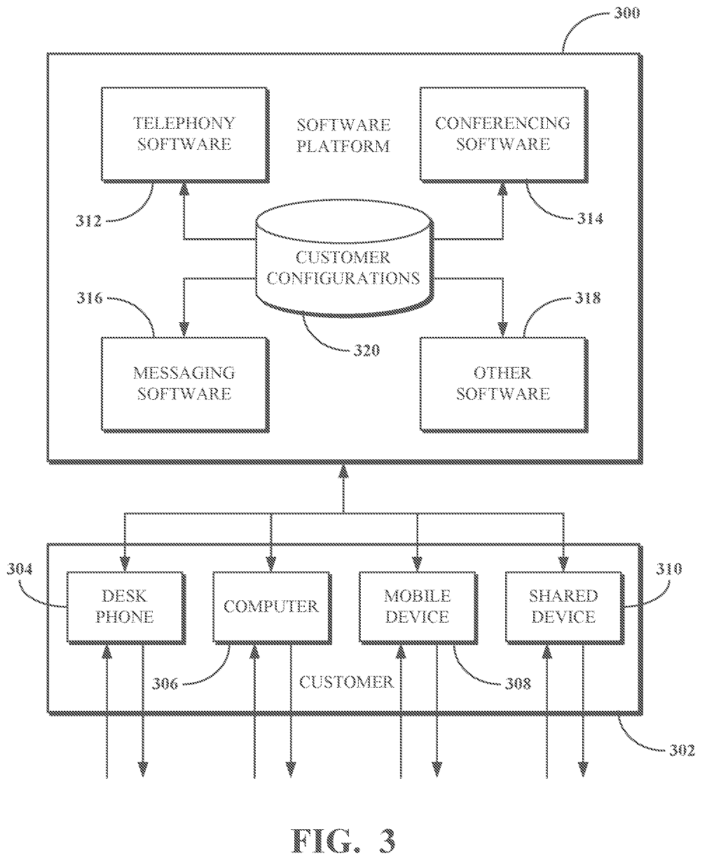

FIG. 3 is a block diagram of an example of a software platform 300 implemented by an electronic computing and communications system, for example, the system 100 shown in FIG. 1. The software platform 300 is a UCaaS platform accessible by clients of a customer of a UCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients—a desk phone 304, a computer 306, a mobile device 308, and a shared device 310. The desk phone 304 is a desktop unit configured to at least send and receive calls and includes an input device for receiving a telephone number or extension to dial to and an output device for outputting audio and/or video for a call in progress. The computer 306 is a desktop, laptop, or tablet computer including an input device for receiving some form of user input and an output device for outputting information in an audio and/or visual format. The mobile device 308 is a smartphone, wearable device, or other mobile computing aspect including an input device for receiving some form of user input and an output device for outputting information in an audio and/or visual format. The desk phone 304, the computer 306, and the mobile device 308 may generally be considered personal devices configured for use by a single user. The shared device 310 is a desk phone, a computer, a mobile device, or a different device which may instead be configured for use by multiple specified or unspecified users.

Each of the clients 304 through 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may, for example, be data stored within a database or other data store at a database server, such as the database server 110 shown in FIG. 1.

The telephony software 312 enables telephony traffic between ones of the clients 304 through 310 and other telephony-enabled devices, which may be other ones of the clients 304 through 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, be sent or received using the desk phone 304, a softphone running on the computer 306, a mobile application running on the mobile device 308, or using the shared device 310 that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a unique location, for example, a conference room, in which the conferencing software 314 may facilitate a conference between only those participants and using one or more clients within the conference room. In some cases, one or more participants may be physically present within a specific location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one particular example, the other software 318 can include security software for changing a security configuration of a digital calendar. In another example, the other software 318 can include calendar software for maintaining the digital calendar.

The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some, or all, of the software 312 through 318 may be combined into a single software application run on clients of the customer, such as one or more of the clients 304 through 310.

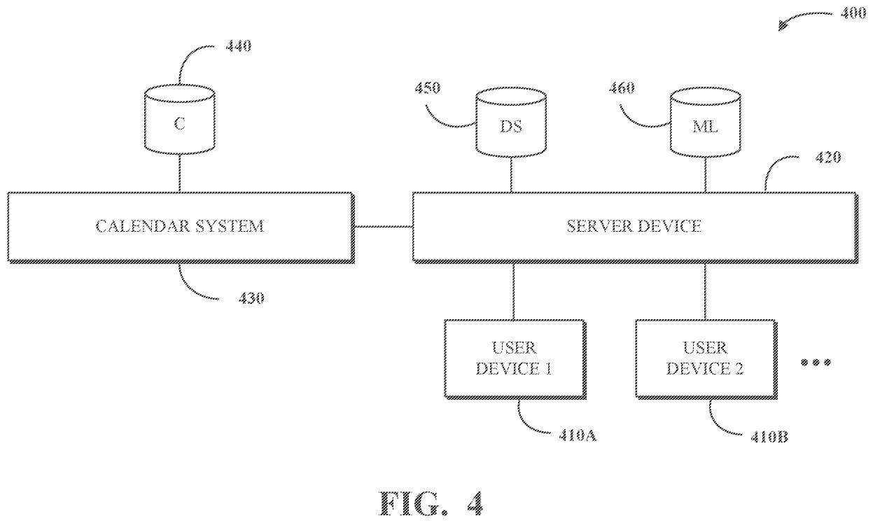

FIG. 4 is a block diagram of an example of a system 400 for changing a security configuration applied to a digital calendar (i.e., calendar). The system 400 may include one or more user devices that can be used by users of the calendar, such as a user device 410A associated with a first user, and a user device 410B associated with a second user. For example, a user device could be a client device such as one of the clients 104A through 104D shown in FIG. 1 or 304 through 310 shown in FIG. 3. Thus, a user device may be a processing system that includes at least a processor and a memory. A user device may execute software (e.g., client-side conferencing software, which could, for example, be via a client application or a web application used to connect to a conference implemented using server-side software, such as the conferencing software 314 shown in FIG. 3, and/or client-side security software, which could, for example, be used to access the calendar when enabled by a security configuration) and may connect to a server device 420. The server device 420 may execute software (e.g., server-side conferencing software, such as the conferencing software 314, to support a video conference between users using the user devices 410A and 410B, and/or server-side security software, such as the other software 318, for changing the security configuration of the calendar). For example, the server device 420 could be a server at the datacenter 106 shown in FIG. 1. Thus, the server device 420 may also be a processing system that includes at least a processor and a memory.

The conferencing software (e.g., the client-side conferencing software and/or the server-side conferencing software) may enable the users to communicate and collaborate with one another in virtual meetings (e.g., video conferencing). The security software (e.g., the client-side security software and/or the server-side security software) may enable the users to access the calendar when enabled by the security configuration. Although two user devices (e.g., the user devices 410A and 410B) are shown, other numbers of user devices may be used in the system 400.

The server device 420 may use an application programming interface (API) to communicate with a calendar system 430. The calendar system 430 may execute calendar software for maintaining the calendar for users of the user devices (e.g., the user devices 410A and 410B). For example, the calendar system 430 may maintain a calendar (e.g., shown as “C” in FIG. 4) in a data store 440. The calendar system 430 may be a third party system external to a software platform (e.g., a UCaaS platform) that uses the conferencing software and/or the security software. In some such cases, where an API of such a third party system is exposed, the processing system can make calls to the API to request and receive calendar information, as described above. In some implementations, the server device 420 may execute the calendar software (e.g., server-side calendar software, such as the other software 318) for maintaining the calendar. The calendar may correspond to one of the users (e.g., the first user, associated with the user device 410A, may be an owner of the calendar). While one calendar is described by way of example, multiple calendars may be present in the system 400, such as a second calendar in the data store 440, owned by another of the users (e.g., the second user, associated with the user device 410B), and/or a third calendar in the data store 440, owned by an entity (e.g., a company, school, or other organization to which the first user and/or the second user belong).

The calendar may include one or more events (e.g., one or more scheduled meetings). An event may include multiple event details, such as a date, a time, a title, a location (e.g., a physical location or a virtual location), a list of invitees (e.g., email address aliases), content, and a prediction. The content could be, for example, an attachment to the event, such as a document (e.g., a file) or a link (e.g., a uniform resource locator (URL) or web link). The prediction could be, for example, a prediction that the event will occur as scheduled or be rescheduled, a prediction that one or more invitees will attend the event or will not show, or a prediction that one or more invitees will speak more during the event more than one or more other invitees.

A processing system, such as the server device 420, may use the security software to apply a security configuration to the calendar (e.g., the calendar in the data store 440). The security configuration may limit access to the events, and the event details associated with the events, to the owner of the calendar (e.g., the first user). This could be, for example, a default configuration. Other possible users of the calendar (e.g., non-owners of the calendar, which could be schedulers of events or invitees to events, such as the second user), may not have access to the events and/or the event details.

The server device 420 may use the security software to access a data structure (e.g., shown as “DS” in FIG. 4) in a data store 450. In some implementations, the data structure may be maintained by a third party system, and the server device 420 may access the data structure via an API. The data structure could include, for example, an organizational chart, a favorite contacts list, a notification breakthrough list, or memberships to a chat channel. The data structure may include data indicating a group of users, including the first user and/or the second user, and data indicating multiple user attributes associated with users in the group, such as a user attribute associated with the first user and/or a user attribute associated with the second user. The user attributes may include, for example, a position in an organization (e.g., a title or role), an identification in a contacts list or a favorite contacts list, a membership to a chat channel, or a network or domain corresponding to a device.

The server device 420 may use the data specified in the data structure to determine connections between users. The connections can be determined based on the user attributes. The server device 420 may use the data specified in the data structure to determine a connection between the first user and the second user based on a user attribute associated with the first user and/or a user attribute associated with the second user. For example, the connection could include the first user being senior to or subordinate to the second user in an organization, the first user and the second user belonging to a same team, department, or project in the organization (e.g., sharing a user attribute), or the first user and the second user having a personal, familial, or business relationship. The server device 420 may use the connections to configure one or more rules for determining access to one or more event details by non-owners of the calendar (e.g., the second user). For example, the server device 420 may change the security configuration applied to the calendar to grant access to a particular event detail of an event to the second user based on a connection between the first user and the second user (e.g., the second user having a personal, familial, or business relationship with the first user that is related to the event, or the first user and the second user sharing a user attribute, such as belonging to a same team, department, or project in the organization, or having a personal, familial, or business relationship). Changing the security configuration may enable an output of the event detail to the user device 410B associated with the second user.

As a result, the owner of the calendar (e.g., the first user) may allow access to particular event details to one or more users (e.g., the second user) while reducing the burden on the owner of individually managing permissions for the one or more users. For example, the owner of the calendar can efficiently grant access to particular event details on the calendar to a single user (e.g., the second user), or a group of users (e.g., a group including the second user), based on a user attribute, such as a title, role, or position of the user or the group of users in the organization.

In some implementations, the server device 420 may use a machine learning model (e.g., shown as “ML” in FIG. 4) maintained in a data store 460. The server device 420 may use the machine learning model, for example, to make a prediction that may serve as an event detail (i.e., the machine learning model may predict the event detail). For example, the prediction could be that the event will occur as scheduled, that one or more invitees will attend the event, or that one or more invitees will speak more during the event more than one or more other invitees. In such cases, the machine learning model may be trained, for example, using past event information, such as attendance of a past event by a user, or speaking during a past event by a user.

In some implementations, the server device 420 may use the machine learning model to select the event detail that may be output to a device (e.g., accessed). For example, the machine learning model may select the date, the time, the title, the location, the list of invitees, the content, and/or the prediction associated with an event to be shared with a non-owner of the calendar. In such cases, the machine learning model may be trained, for example, using past event information, such as an invitee of a past event.

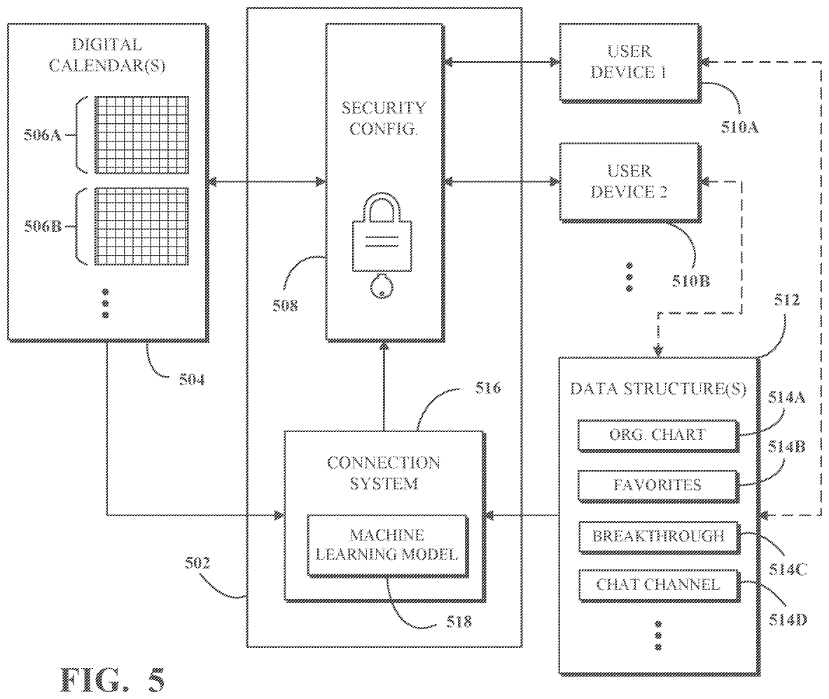

FIG. 5 is a block diagram of an example of using security software 502 for changing a security configuration 508 applied to a digital calendar. For example, a processing system, such as the server device 420 shown in FIG. 4, could use the security software 502. The security software 502 may communicate with calendar software 504, such as via an API. For example, the calendar software 504 could be implemented by a calendar system like the calendar system 430 shown in FIG. 4. In some cases, the calendar software 504 could also be implemented by the server device 420. The calendar software 504 may maintain one or more calendars, such as a first calendar 506A and a second calendar 506B. The one or more calendars may be maintained in a data store like the data store 440 shown in FIG. 4. The first calendar 506A could correspond to a first user (e.g., a first user associated with a user device 510A, like the user device 410A). The second calendar 506B could correspond to a second user (e.g., a second user associated with a user device 510B, like the user device 410B). The one or more calendars may include events, and the events may include event details (e.g., a date, a time, a title, a location, a list of invitees, content, and/or a prediction). The security software 502 may apply a security configuration 508 to limit access to the events and/or the event details on the one or more calendars to the owners of the particular calendars. For example, the security configuration 508 may limit access to the events and/or the event details on the first calendar 506A to the first user associated with the user device 510A, and may limit access to the events and/or the event details on the second calendar 506B to the second user associated with the user device 510B. This could be, for example, a default configuration.

The security configuration 508 may be changed to link access to one or more event details on the one or more calendars to connections between users of the one or more calendars. For example, the security configuration 508 may link access to an event detail on the first calendar 506A, owned by the first user, to the user device 510B associated with the second user, based on a connection between the first user and second user. To do so, the security software 502 may access a data structure 512 in a data store. The data structure 512 may be maintained in a data store like the data store 450 shown in FIG. 4. For example, the data structure could include an organizational chart 514A, a favorite contacts list 514B, a notification breakthrough list 514C, and/or memberships to a chat channel 514D. The data structure may include data indicating a group of users, such as the first user and/or the second user, and data indicating multiple user attributes associated with users in the group, such as a user attribute associated with the first user and/or a user attribute associated with the second user. The user attributes may include, for example, a position in an organization (e.g., a title or role), an identification in a contacts list or a favorite contacts list, a membership to a chat channel, or a network or domain corresponding to a device.

The security software 502 may determine connections between the first user and the second user based on the user attributes associated with the first user and/or the second user, respectively. For example, the security software 502 may determine a connection between the first user and the second user based on user attributes indicating the first user being senior to the second user, and/or the second user being subordinate to the first user, on a same team (e.g., an engineering team). The security configuration 508 may link access to an event detail on the first calendar 506A, owned by the first user, to the user device 510B associated with the second user, based on such connections between the first user and the second user. In other examples, the security software 502 may determine connections between the first user and the second user based on user attributes indicating the first user and the second user being in a same department (e.g., research and development) or assigned to same project (e.g., of multiple projects assigned to the same team), or the first user and the second user having a personal relationship (e.g., being members of a same club), a familial relationship (e.g., being spouses, siblings, or of other relation), or a business relationship (e.g., being customers or clients of a same entity, or of one another).

The security software 502 may include a connection system 516 to determine the connections from the data structure 512. The connection system 516 may analyze the user attributes in the data structure 512 to determine the connections. In some implementations, the connection system 516 may use a machine learning model 518 to determine the connections. For example, machine learning model 518 may be used to learn the behaviors of the users. The machine learning model 518 may be maintained in a data store like the data store 460 shown in FIG. 4. The machine learning model 518 may be trained using a training data set including data samples representing user attributes in data structures, like the data structure 512, and/or past event information on one or more calendars, such as the first calendar 506A and/or the second calendar 506B. The training data set can enable the machine learning model 518 to learn patterns, such as relationships between users based on organization, team, department, or project, and/or personal, familial, or business relationships. The machine learning model 518 may be trained to determine connections from the patterns. The training can be periodic, such as by updating the machine learning model 518 on a discrete time interval basis (e.g., once per week or month), or otherwise. The training data set may derive from multiple data structures (e.g., the organizational chart 514A, the favorite contacts list 514B, the notification breakthrough list 514C, and/or memberships to a chat channel 514D) and/or multiple calendars (e.g., the first calendar 506A and the second calendar 506B) or may be specific to a particular data structure (e.g., the organizational chart 514A) or particular calendar (e.g., the first calendar 506A). The training data set may in some cases avoid using certain data samples that are determined to be outliers, such as based on events occurring other than for a certain team, department, or project in an organization, or a certain personal, familial, or business relationship. The machine learning model 518 may, for example, be or include one or more of a neural network (e.g., a convolutional neural network, recurrent neural network, deep neural network, or other neural network), decision tree, vector machine, Bayesian network, cluster-based system, genetic algorithm, deep learning system separate from a neural network, or other machine learning model.

The connection system 516 may use the connections, determined from the data structure 512, to configure one or more rules for determining access to one or more event details on the one or more calendars. For example, the connection system 516 may configure a rule that enables the first user, being senior to the second user, to access all event details on the second user's calendar. In another example, the connection system 516 may configure a rule that enables the second user, being subordinate to the first user, to access only the date, the time, and the title of an event on the first user's calendar for an event that includes a list of invitees including the second user. In another example, the connection system 516 may configure a rule that enables the first user to access only event details for events on the second user's calendar that relate to the same department or the same project to which the first user and the second user are assigned (e.g., sharing a user attribute). In another example, the connection system 516 may configure a rule that enables the first user to access only event details for events on the second user's calendar that relate to a personal relationship, a familial relationship, or a business relationship between the first user and the second user. In another example, the connection system 516 may configure a rule that enables a second user that is an entity associated with network or domain to access only event details for events on the first users' calendar that are relevant to the entity, such scheduled meetings with the entity, or attachments that are relevant to the entity. The connection system 516 may change the security configuration 508, based on the rules, to grant access to one or more event details to a device associated with a user based on the connections. Changing the security configuration 508 may enable an output of an event detail to a device (e.g., the user device 510A or the user device 510B) associated with a user that is authorized to receive that event detail.

The security configuration 508 may be configured to grant access to event details in different ways. For example, the security configuration 508 may grant access to a greater number of event details on the calendar corresponding to the second user (e.g., the second calendar 506B) to the device associated with the first user, while granting access to a lesser number of event details on the calendar corresponding to the first user (e.g., the first calendar 506A) to the device associated with the second user. In this example, the first user may be senior to the second user on a same team. In another example, the security configuration 508 may grant access to a first event detail on the calendar corresponding to the first user (e.g., the first calendar 506A) to a device associated with the second user, while denying access to a second event detail on the calendar, and while granting access to the second event detail on the calendar to a device associated with a third user. In this example, the third user may have a different position or role than the second user, such that the third user may receive the second event detail. For example, the second event detail could be content (e.g., an attachment or a link) that is relevant to a group to which the third user belongs (e.g., sales or marketing), but is not relevant to a group to which the second user belongs (e.g., engineering).

In some implementations, the security software 502 may assign a weight to users based on user attributes. For example, the security software 502 may assign a higher weight to a first user, and a lower weight to a second user, based on the first user being senior to the second user, and/or the second user being subordinate to the first user, in an organization. The weight may enable the security software 502 to give a preference to one user over another, such as for changing an event detail. For example, the first user having the higher weight may enable the first user to override a change to an event detail made by the second user, such as for an event on the calendar of the second user or on a calendar of a third user.

In some implementations, the security software 502 may use the machine learning model 518 to make a prediction that may serve as an event detail (i.e., the machine learning model 518 may predict the event detail), such as an event detail for an event on the first calendar 506A. For example, the prediction could be that the event will occur as scheduled, that one or more invitees will attend the event, or that one or more invitees will speak more during the event more than one or more other invitees. In such cases, the machine learning model 518 may be trained using a training data set including data samples representing past event information on the one or more calendars, such as past event information on the first calendar 506A. The training data set can enable the machine learning model 518 to learn patterns, such as attendance of a past event by a user indicated in the data structure 512 or speaking during a past event by a user indicated in the data structure 512 (e.g., as measured by transcriptions of video conferences). In some implementations, the security software 502 may use the machine learning model 518 to negotiate schedules between users. For example, based on the connections, the machine learning model 518 may predict an event, including event details, between users and may schedule the event on the calendars of the users.

In some implementations, the security software 502 may use the machine learning model 518 to select the event detail that may be output to a device (e.g., accessed), such as an event detail for an event on the first calendar 506A. For example, the machine learning model 518 may select the date, the time, the title, the location, the list of invitees, the content, and/or the prediction associated with an event to be shared with a non-owner of the calendar. In such cases, the machine learning model 518 may be trained, for example, using past event information, such as an invitee of a past event. In such cases, the machine learning model 518 may be trained using a training data set including data samples representing past event information on the one or more calendars, such as past event information on the first calendar 506A. The training data set can enable the machine learning model 518 to learn patterns, such as invitees of past events, or events that may be related to one another based on a same team, department, or project in an organization, or a personal, familial, or business relationship.

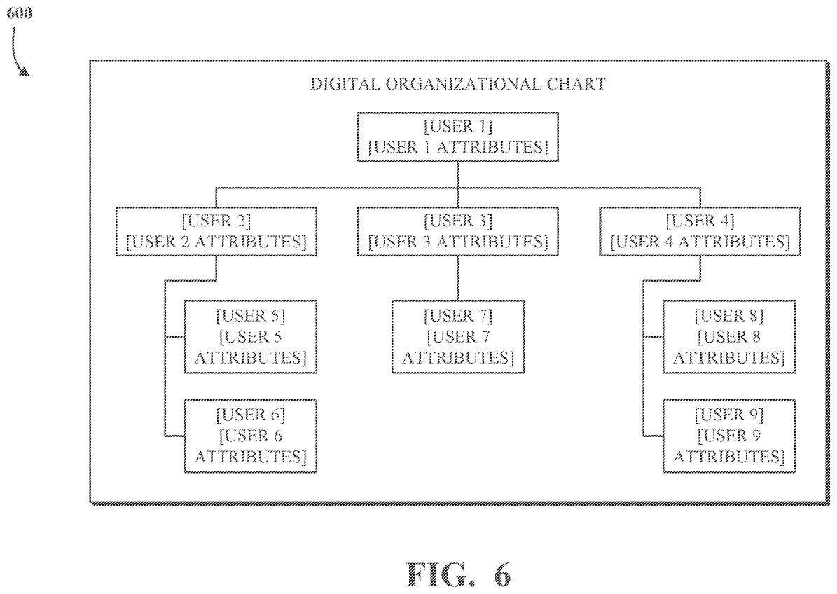

FIG. 6 is a block diagram of an example of a data structure 600 including an organizational chart. The data structure 600 could be the data structure in the data store 450 shown in FIG. 4 or the data structure 512 shown in FIG. 5. For example, the organizational chart could be the organizational chart 514A. The organizational chart may be a diagram that shows the structure of an organization with the relationships and relative ranks of a group of users in the organization, such as the relationships and relative ranks of “User 1” through “User 9.” The users in the group may be users of a digital calendar like the calendar in the data store 440, or the first calendar 506A or the second calendar 506B shown in FIG. 5. The users in the group may be associated with user attributes, such as “User 1” having “User 1 Attributes,” and “User 2” having “User 2 Attributes.” The user attributes may indicate, for example, a position of a user in the organization, such as membership on a team, department, or project in the organization, and/or may indicate business relationships, titles, roles, responsibilities, contact information (e.g., phone, email, instant messaging, or video conferencing address), equipment (e.g., devices like the user device 410A or the user device 410B), or networks or domains (e.g., corresponding to the equipment, such as the devices). The organizational chart may be arranged in a hierarchy with links between users, such as “User 1” above “User 2” with a link between “User 1” and “User 2,” and the links may indicate additional user attributes, such as “User 1” being senior to “User 2,” or “User 5” and “User 6” being lateral to one another on a same team. Based on the users in the group, and the user attributes associated with the users, security software (e.g., the security software 502) may determine connections for changing a security configuration (e.g., the security configuration 508) for accessing one or more calendars.

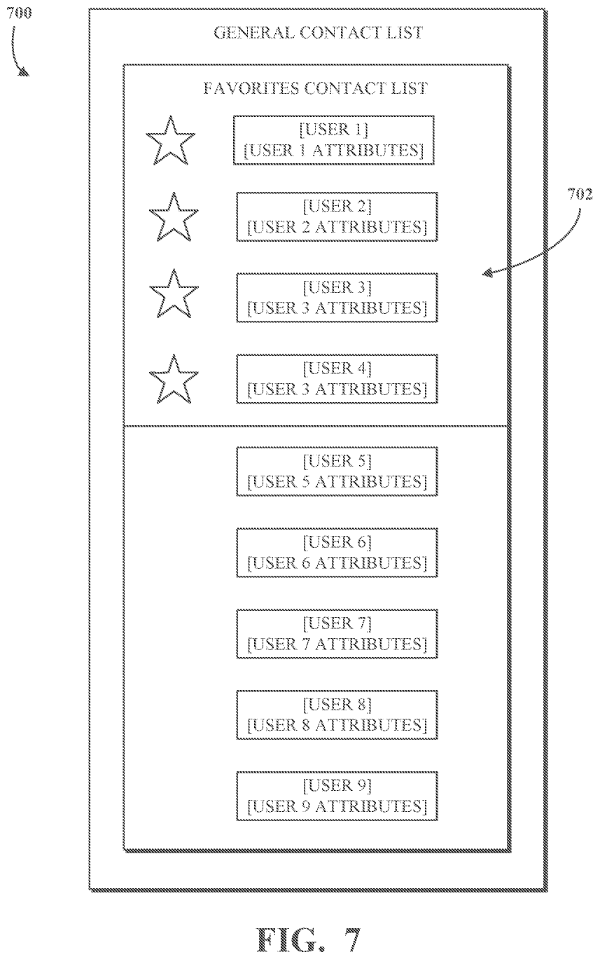

FIG. 7 is a block diagram of an example of a data structure 700 including a favorite contacts list 702. The data structure 700 could be the data structure in the data store 450 shown in FIG. 4 or the data structure 512 shown in FIG. 5. For example, the favorite contacts list 702 could be the favorite contacts list 514B. The favorite contacts list 702 could also be stored on a device for use by a user, such as being stored on the user device 410A for use by the first user. The favorite contacts list 702 may include a group of users, indicated by stars, among a larger group of users in a general contacts list. For example, the general contacts list may include “User 1” through “User 9.” and the favorite contacts list 702 may include a subset of that, such as “User 1” through “User 4.” The general contacts list may be used to contact a particular user, such as by phone, email, instant messaging, or video conferencing, and the favorite contacts list 702 may be used to enable faster, more efficient contact of certain users than in the general contacts list (e.g., colloquially a speed dial). The users may be users of a digital calendar like the calendar in the data store 440, or the first calendar 506A or the second calendar 506B shown in FIG. 5. The users may be associated with user attributes, such as “User 1” having “User 1 Attributes,” and “User 2” having “User 2 Attributes.” The user attributes may indicate, for example, identification of a user in the favorite contacts list 702, a position of the user in an organization, such as membership on a team, department, or project in the organization, business relationships, titles, roles, responsibilities, contact information (e.g., phone, email, instant messaging, or video conferencing address), equipment (e.g., devices like the user device 410A or the user device 410B), or networks or domains (e.g., corresponding to the equipment, such as the devices). Based on the users in the group (e.g., the favorite contacts list 702, such as “User 1” through “User 4”), and the user attributes associated with the users, security software (e.g., the security software 502) may determine connections for changing a security configuration (e.g., the security configuration 508) for accessing one or more calendars.

In some implementations, the data structure 700 could include a notification breakthrough list. For example, users in the favorite contacts list 702 (e.g., “User 1” through “User 4”) could be users associated with a notification breakthrough list. The notification breakthrough list could be like the notification breakthrough list 514C shown in FIG. 5. The user attributes may indicate, for example, identification of a user on the notification breakthrough list. The notification breakthrough list may enable users on the list to break through a do not disturb rule set up by a user, such as for causing an alert to occur to the user when another user on the notification breakthrough list contacts the user. Based on the users in the notification breakthrough list, and the user attributes associated with the users, the security software may determine connections for changing a security configuration for accessing one or more calendars.

In some implementations, the data structure 700 could include memberships to a chat channel. For example, users in the favorite contacts list 702 (e.g., “User 1” through “User 4”) could be members of the chat channel. A chat channel may comprise a private or public group where messages, files or images can be sent, or instant meetings (e.g., video conferences) can be started. The membership to the chat channel in the data structure 700 could be like the memberships to a chat channel 514D shown in FIG. 5. The user attributes may indicate, for example, identification of a user as a member of the chat channel. Based on the users in the memberships to the chat, and the user attributes associated with the users, the security software may determine connections for changing a security configuration for accessing one or more calendars.

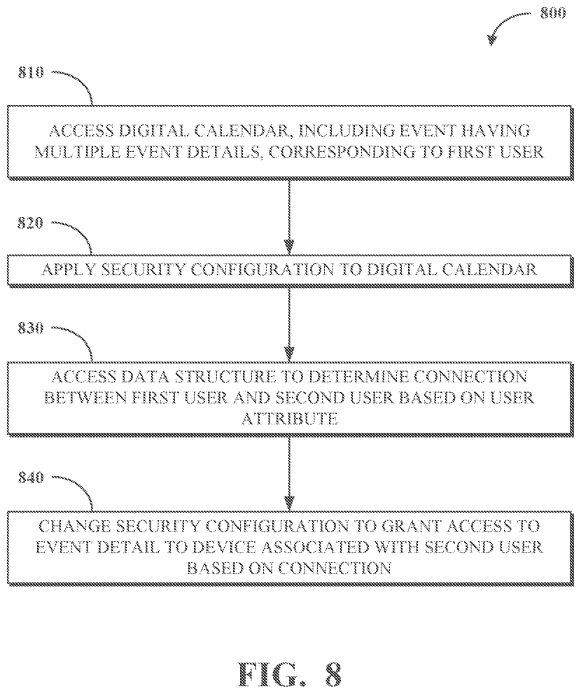

To further describe some implementations in greater detail, reference is next made to examples of techniques which may be performed by or using a system for changing a security configuration applied to a digital calendar. FIG. 8 is a flowchart of an example of a technique for changing the security configuration. The technique 800 can be executed using computing devices, such as the systems, hardware, and software described with respect to FIGS. 1-7. The technique 800 can be performed, for example, by executing a machine-readable program or other computer-executable instructions, such as routines, instructions, programs, or other code. The steps, or operations, of the technique 800 or another technique, method, process, or algorithm described in connection with the implementations disclosed herein can be implemented directly in hardware, firmware, software executed by hardware, circuitry, or a combination thereof.

For simplicity of explanation, the technique 800 is depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

At 810, a system may access a digital calendar, including an event (e.g., a scheduled meeting) having multiple event details, corresponding to a first user. For example, a server device (e.g., the server device 420), using security software (e.g., the security software 502) may access a calendar like the calendar in the data store 440, or the first calendar 506A or the second calendar 506B shown in FIG. 5. The calendar may be maintained by a calendar system that is a third party system external to a software platform (e.g., a UCaaS platform) that uses the security software. However, in some implementations, the system that uses the security software may be the same system that uses the calendar software to maintain the calendar. The multiple event details could include, for example, a date, a time, a title, a location, a list of invitees, content, and a prediction.

At 820, the system may apply a security configuration to the calendar. For example, the system may apply a security configuration like the security configuration 508 shown in FIG. 5. The system may use the security software to apply the security configuration. The security configuration may limit access to the event having multiple event details to the first user (e.g., an owner of the calendar). This could be, for example, a default configuration. Limiting the access to the first user may prevent other users from accessing the event, including the multiple event details. For example, other possible users of the calendar (e.g., non-owners of the calendar, which could be schedulers of events or invitees to events), may not have access to the event or the multiple event details.

At 830, the system may access a data structure to determine a connection between the first user and a second user based on a user attribute. For example, the system may access a data structure like the data structure in the data store 450 or the data structure 512 shown in FIG. 5. The data structure could include an organizational chart (e.g., the data structure 600), a favorite contacts list (e.g., the data structure 700), a notification breakthrough list, or memberships to a chat channel. The data structure may indicate a group of users, including the first user and/or the second user, and may indicate multiple user attributes associated with users in the group of users, including a user attribute associated with the first user and/or a user attribute associated with the second user. The user attributes may include, for example, a position in an organization (e.g., a title or role), an identification in a contacts list or a favorite contacts list, a membership to a chat channel, or a network or domain corresponding to a device. The system may determine a connection between the first user and the second user based on the user attribute associated with the first user and/or the user attribute associated with the second user. For example, the connection could include the first user being senior to or subordinate to a second user in an organization, the first user and the second user belonging to a same team, department, or project in the organization, or the first user and the second user having a personal, familial, or business relationship. The system may use the connection to configure one or more rules for determining access to an event detail of an event on the calendar for the second user.

At 840, the system may change a security configuration to grant access to the event detail to a device associated with the second user based on the connection. The system may change the security configuration to grant access to the event detail of the multiple event details of the event to a device associated with the second user based on the connection between the first user and the second user. Changing the security configuration may enable an output of the event detail to the device associated with the second user. As a result, the owner of a calendar (e.g., the first user) may allow access to particular event details to one or more users (e.g., the second user) while reducing the burden on the owner of individually managing permissions for the one or more users. For example, the owner of the calendar can efficiently grant access to particular event details on the calendar to a single user (e.g., the second user), or a group of users (e.g., a group including the second user), based on the user attribute, such as the title, role, or position of the user or the group of users in the organization.

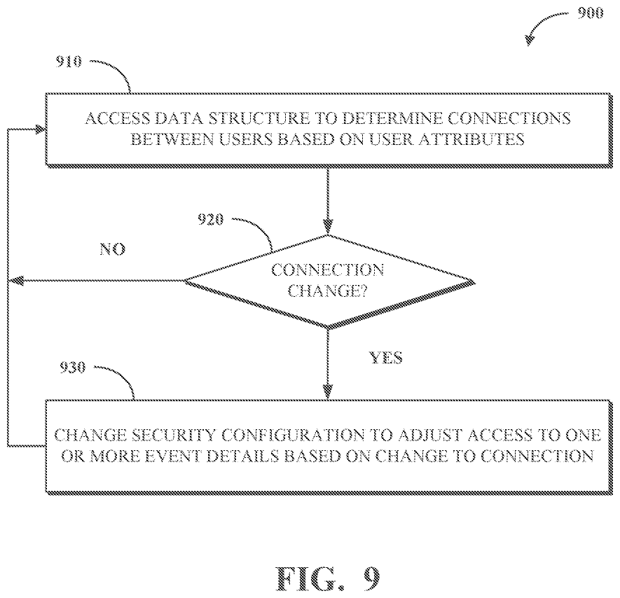

FIG. 9 is a flowchart of an example of a technique for monitoring for a connection change based on a user attribute. The technique 900 can be executed using computing devices, such as the systems, hardware, and software described with respect to FIGS. 1-7. The technique 900 can be performed, for example, by executing a machine-readable program or other computer-executable instructions, such as routines, instructions, programs, or other code. The steps, or operations, of the technique 900 or another technique, method, process, or algorithm described in connection with the implementations disclosed herein can be implemented directly in hardware, firmware, software executed by hardware, circuitry, or a combination thereof.

For simplicity of explanation, the technique 900 is depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

At 910, a system may access a data structure to determine connections between users based on user attributes. For example, a server device (e.g., the server device 420), using security software (e.g., the security software 502) may access a data structure like the data structure in the data store 450 or the data structure 512 shown in FIG. 5. The system may access the data structure to determine connections between users (e.g., the first user associated with the user device 410A, and/or the second user associated with the user device 410B, shown in FIG. 4) based on user attributes. The data structure could include an organizational chart (e.g., the data structure 600), a favorite contacts list (e.g., the data structure 700), a notification breakthrough list, or memberships to a chat channel. The data structure may indicate a group of users including the first user and/or the second user and may indicate multiple user attributes associated with users in the group of users including a user attribute associated with the first user and/or a user attribute associated with the second user. The user attributes may include, for example, a position in an organization (e.g., a title or role), an identification in a contacts list or a favorite contacts list, a membership to a chat channel, or a network or domain corresponding to a device. The system may determine connections between users based on the user attributes. For example, the connections could include the first user being senior to or subordinate to a second user in an organization, the first user and the second user belonging to a same team, department, or project in the organization, or the first user and the second user having a personal, familial, or business relationship. The system may use the connections to configure one or more rules for determining access to events and/or event details on a digital calendar as part of a security configuration.

At 920, the system may determine whether one or more connections between users have changed (e.g., monitoring for a connection change). If no connections have changed (“No”), the system may return to 910 to access the data structure again at a later time (e.g., monitoring for an update). For example, accessing the data structure can be periodic, such as on a discrete time interval basis (e.g., once per week or month), or otherwise. However, if at 920 a connection has changed (“Yes”), at 930, the system may change the security configuration to adjust access to one or more event details based on the change to the connection. For example, the data structure could include the organizational chart, and at some point, the organizational chart may change, such as to indicate that a user has been assigned to a different team, department, or project, or has been promoted to a senior position. This change may represent a change in a user attribute associated with the user, and the change in the user attribute could cause a change in one or more connections between users. This could cause the change to the security configuration. The system may then return to 910 to access the data structure again at a later time for determining again whether one or more connections between users have changed (e.g., continued monitoring for a connection change).

Some implementations may include a method that includes applying a security configuration to a digital calendar corresponding to a first user, the digital calendar being maintained by calendar software to include an event having multiple event details including a date for the event and a time for the event, wherein access to the multiple event details are limited to the first user by the security configuration; accessing a data structure in a data store to determine a connection between the first user and a second user based on a user attribute associated with the second user; and changing the security configuration to grant access to an event detail of the multiple event details to a device associated with the second user based on the connection between the first user and the second user. In some implementations, the data structure includes at least one of an organizational chart, a favorite contacts list, a notification breakthrough list, or memberships to a chat channel. In some implementations, the user attribute includes at least one of a position of the second user in an organization, an identification of the second user in a favorite contacts list, a membership of the second user to a chat channel, or a network or domain corresponding to the device used by the second user. In some implementations, the method may include using a machine learning model, trained using past event information including an invitee of a past event, to select the event detail. In some implementations, the method may include using a machine learning model, trained using past event information including at least one of attendance of a past event by a user indicated in the data structure or speaking during a past event by a user indicated in the data structure, to predict the event detail. In some implementations, the method may include assigning a weight to the second user based on the user attribute; and changing the event detail, wherein the weight gives the second user a preference over another user to change the event detail. In some implementations, the method may include granting access to the event detail to multiple users indicated in the data structure based on the multiple users sharing the user attribute. In some implementations, the method may include accessing the data structure to determine a connection between the first user and a third user based on a user attribute associated with the third user; and changing the security configuration to grant access to a second event detail of the multiple event details to a device associated with the third user based on the connection between the first user and the third user, wherein changing the security configuration limits access to the second event detail so that the second user does not have access. In some implementations, the data structure indicates a group of users including the second user and indicates multiple user attributes associated with users in the group of users including the user attribute.

Some implementations may include an apparatus that includes a memory and a processor. The processor may be configured to execute instructions stored in the memory to apply a security configuration to a digital calendar corresponding to a first user, the digital calendar being maintained by calendar software to include an event having multiple event details including a date for the event and a time for the event, wherein access to the multiple event details are limited to the first user by the security configuration; access a data structure in a data store to determine a connection between the first user and a second user based on a user attribute associated with the second user; and change the security configuration to grant access to an event detail of the multiple event details to a device associated with the second user based on the connection between the first user and the second user. In some implementations, the processor is further configured to execute instructions stored in the memory to use a machine learning model, trained using past event information including an invitee of a past event, to select the event detail. In some implementations, the processor is further configured to execute instructions stored in the memory to use a machine learning model, trained using past event information including at least one of attendance of a past event by a user indicated in the data structure or speaking during a past event by a user indicated in the data structure, to predict the event detail. In some implementations, the processor is further configured to execute instructions stored in the memory to assign a weight to the second user based on the user attribute; and change the event detail, wherein the weight gives the second user a preference over another user to change the event detail. In some implementations, the processor is further configured to execute instructions stored in the memory to grant access to the event detail to multiple users indicated in the data structure based on the multiple users sharing the user attribute. In some implementations, the processor is further configured to execute instructions stored in the memory to access the data structure to determine a connection between the first user and a third user based on a user attribute associated with the third user; and change the security configuration to grant access to a second event detail of the multiple event details to a device associated with the third user based on the connection between the first user and the third user, wherein changing the security configuration limits access to the second event detail so that the second user does not have access.

Some implementations may include a non-transitory computer readable medium storing instructions operable to cause one or more processors to perform operations that include applying a security configuration to a digital calendar corresponding to a first user, the digital calendar being maintained by calendar software to include an event having multiple event details including a date for the event and a time for the event, wherein access to the multiple event details are limited to the first user by the security configuration; accessing a data structure in a data store to determine a connection between the first user and a second user based on a user attribute associated with the second user; and changing the security configuration to grant access to an event detail of the multiple event details to a device associated with the second user based on the connection between the first user and the second user. In some implementations, the operations further include using a machine learning model, trained using past event information including an invitee of a past event, to select the event detail. In some implementations, the operations further include using a machine learning model, trained using past event information including at least one of attendance of a past event by a user indicated in the data structure or speaking during a past event by a user indicated in the data structure, to predict the event detail. In some implementations, the operations further include assigning a weight to the second user based on the user attribute; and changing the event detail, wherein the weight gives the second user a preference over another user to change the event detail. In some implementations, the operations further include granting access to the event detail to multiple users indicated in the data structure based on the multiple users sharing the user attribute.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
applying a security configuration to a digital calendar corresponding to a first user, the digital calendar being maintained by calendar software to include an event having multiple event details including a date for the event and a time for the event, wherein access to the multiple event details are limited to the first user by the security configuration;
accessing a data structure in a data store to determine a connection between the first user and a second user based on a user attribute associated with the second user; and
changing the security configuration to grant access to an event detail of the multiple event details to a device associated with the second user based on the connection between the first user and the second user.

2. The method of claim 1, wherein the data structure includes at least one of an organizational chart, a favorite contacts list, a notification breakthrough list, or memberships to a chat channel.

3. The method of claim 1, wherein the user attribute includes at least one of a position of the second user in an organization, an identification of the second user in a favorite contacts list, a membership of the second user to a chat channel, or a network or domain corresponding to the device used by the second user.

4. The method of claim 1, further comprising:
using a machine learning model, trained using past event information including an invitee of a past event, to select the event detail.

5. The method of claim 1, further comprising:
using a machine learning model, trained using past event information including at least one of attendance of a past event by a user indicated in the data structure or speaking during a past event by a user indicated in the data structure, to predict the event detail.

6. The method of claim 1, further comprising:
assigning a weight to the second user based on the user attribute; and
changing the event detail, wherein the weight gives the second user a preference over another user to change the event detail.

7. The method of claim 1, further comprising:
granting access to the event detail to multiple users indicated in the data structure based on the multiple users sharing the user attribute.

8. The method of claim 1, further comprising:
accessing the data structure to determine a connection between the first user and a third user based on a user attribute associated with the third user; and
changing the security configuration to grant access to a second event detail of the multiple event details to a device associated with the third user based on the connection between the first user and the third user,
wherein changing the security configuration limits access to the second event detail so that the second user does not have access.

9. The method of claim 1, wherein the data structure indicates a group of users including the second user and indicates multiple user attributes associated with users in the group of users including the user attribute.

10. An apparatus, comprising:
a memory; and
a processor configured to execute instructions stored in the memory to:
apply a security configuration to a digital calendar corresponding to a first user, the digital calendar being maintained by calendar software to include an event having multiple event details including a date for the event and a time for the event, wherein access to the multiple event details are limited to the first user by the security configuration;
access a data structure in a data store to determine a connection between the first user and a second user based on a user attribute associated with the second user; and
change the security configuration to grant access to an event detail of the multiple event details to a device associated with the second user based on the connection between the first user and the second user.

11. The apparatus of claim 10, wherein the processor is further configured to execute instructions stored in the memory to:
use a machine learning model, trained using past event information including an invitee of a past event, to select the event detail.

12. The apparatus of claim 10, wherein the processor is further configured to execute instructions stored in the memory to:
use a machine learning model, trained using past event information including at least one of attendance of a past event by a user indicated in the data structure or speaking during a past event by a user indicated in the data structure, to predict the event detail.

13. The apparatus of claim 10, wherein the processor is further configured to execute instructions stored in the memory to:
assign a weight to the second user based on the user attribute; and
change the event detail, wherein the weight gives the second user a preference over another user to change the event detail.

14. The apparatus of claim 10, wherein the processor is further configured to execute instructions stored in the memory to:
grant access to the event detail to multiple users indicated in the data structure based on the multiple users sharing the user attribute.

15. The apparatus of claim 10, wherein the processor is further configured to execute instructions stored in the memory to:
access the data structure to determine a connection between the first user and a third user based on a user attribute associated with the third user; and
change the security configuration to grant access to a second event detail of the multiple event details to a device associated with the third user based on the connection between the first user and the third user,
wherein changing the security configuration limits access to the second event detail so that the second user does not have access.

16. A non-transitory computer readable medium storing instructions operable to cause one or more processors to perform operations comprising:
applying a security configuration to a digital calendar corresponding to a first user, the digital calendar being maintained by calendar software to include an event having multiple event details including a date for the event and a time for the event, wherein access to the multiple event details are limited to the first user by the security configuration;
accessing a data structure in a data store to determine a connection between the first user and a second user based on a user attribute associated with the second user; and
changing the security configuration to grant access to an event detail of the multiple event details to a device associated with the second user based on the connection between the first user and the second user.

17. The non-transitory computer readable medium storing instructions of claim 16, the operations further comprising:
using a machine learning model, trained using past event information including an invitee of a past event, to select the event detail.

18. The non-transitory computer readable medium storing instructions of claim 16, the operations further comprising:
using a machine learning model, trained using past event information including at least one of attendance of a past event by a user indicated in the data structure or speaking during a past event by a user indicated in the data structure, to predict the event detail.

19. The non-transitory computer readable medium storing instructions of claim 16, the operations further comprising:
assigning a weight to the second user based on the user attribute; and
changing the event detail, wherein the weight gives the second user a preference over another user to change the event detail.

20. The non-transitory computer readable medium storing instructions of claim 16, the operations further comprising:
granting access to the event detail to multiple users indicated in the data structure based on the multiple users sharing the user attribute.
